(19) United States
(12) Patent Application Publication
(10) Pub. No.: US 2023/0177772 A1
(43) Pub. Date: Jun. 8, 2023

(54) Rules of interaction of the 3D Golden Rhombus

(71) Applicant: Dillon Edward Thompson, Newburyport, MA (US)

(72) Inventor: Dillon Edward Thompson, Newburyport, MA (US)

(21) Appl. No.: 17/803,137

(22) Filed: Mar. 3, 2022

Related U.S. Application Data
(60) Provisional application No. 63/361,221, filed on Dec. 6, 2021.

(51) Int. Cl. G06T 19/00

(52) U.S. Cl. CPC G06T 19/00

(57) ABSTRACT

The purpose of this patent is to disclose the process of which the active Rule of Interaction of the 3D Golden Rhombus on an interesting 3D Golden Rhombus's environment develops structural behavior of this Fibonaccian shape, founding the field of A.I. cognition, removing technical problems like being data driven. The Rule of Interaction of the 3D Golden Rhombus under observation is conceptually created, through the collection of amalgams of 3D Golden Rhombuses adding a 3D Golden Rhombus to the center of each of the set, located & oriented on an unbound side of a 3D Golden Rhombus, the placement is dependent on environment. Repeating the following process, a Rule of Interaction of the 3D Golden Rhombus is applied to an interesting 3D Golden Rhombus within an environment of 3D Golden Rhombuses and an additional 3D Golden Rhombus is added to an available side in a deterministic orientation, generating growth.

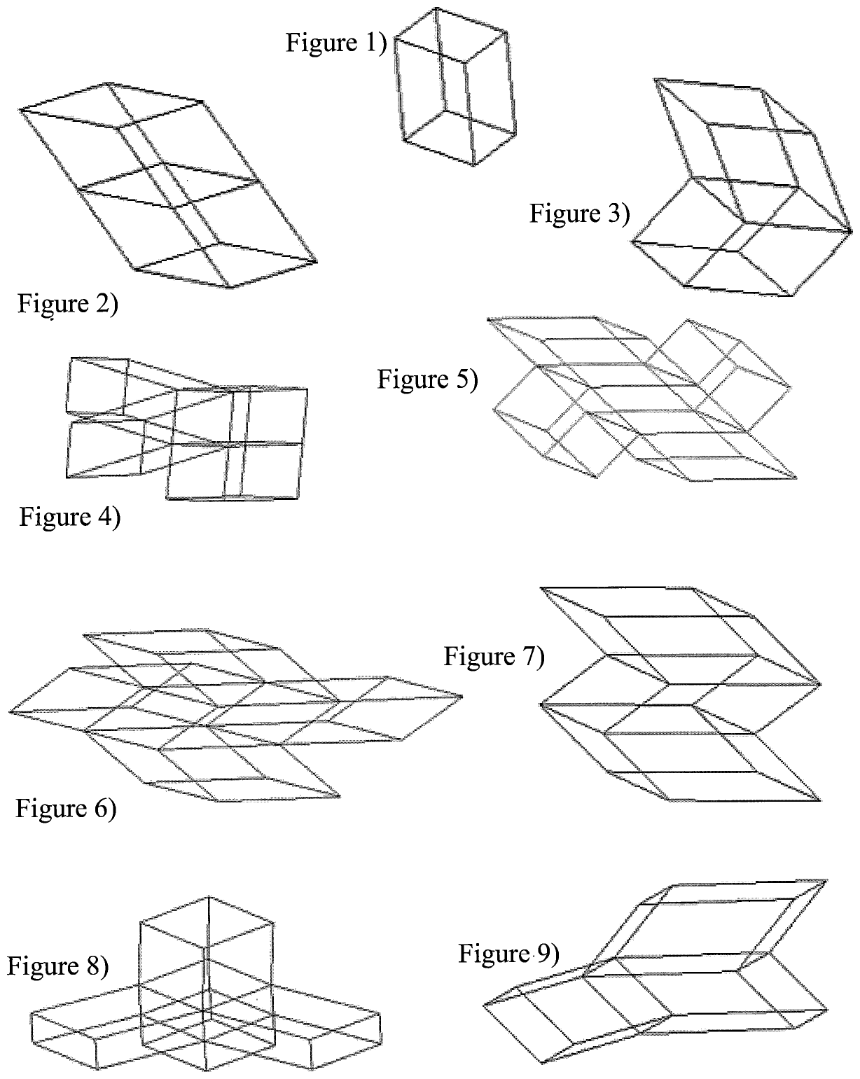

### BACKGROUND OF THE INVENTION

(1) Artificial Intelligence cognitive foundations
(2) U.S. Patent No. 20020091991 discloses a system of hardware and software together with the intent of processing human data to gather interpretable information. The Rules of Interaction of the 3D Golden Rhombus produces complex & deterministic behavior of a 3D Golden Rhombus improving on the concept of hardware and software intelligence design. U.S. Pat. No. 6,842,881 discloses a rule-based system and method for generating things in a specific order. My claim can grow 3D Golden Rhombuses complexly & deterministically, leading to decisions at the level of network design, a vast improvement on scales of ordering things. U.S. Pat. No. 7,217,878 discloses techniques to influence interacting individuals, I improve upon the ability to influence systematic behavior threw the process of activating a Rule of Interaction of the 3D Golden Rhombus on an interesting 3D Golden Rhombus's environment adding deterministically a 3D Golden Rhombus. U.S. Pat. No. 11,321,292 discloses a way giving value to qualitative aspects of information and formulaically outputs. The output of an active Rule of Interaction of the 3D Golden Rhombus is part of a process where a landscape of 3D Golden Rhombuses generate deterministically added 3D Golden Rhombuses. U.S. Pat. No. 1,062,358 discloses a complicated machine operated by multiple specific parts; I claim Rules of Interaction of the 3D Golden Rhombus with the intent of coordinating growth of 3D Golden Rhombuses.

### BRIEF SUMMARY OF THE INVENTION

3D Golden Rhombuses will be virtually interacting on a computer complexly with behavior that depends deterministically on the active Rule of Interaction of the 3D Golden Rhombus and the 3D Golden Rhombus of interest's environment. The number of claimed Rules of Interaction of the 3D Golden Rhombus is predicted in the following equation:

R=S^{S(2n+1)D}

where
S is equal to 3 states, N is equal to 6 neighborhood size and is D is equal to 3 dimensional.

### DETAILED DESCRIPTION OF THE INVENTION

A 3D Golden Rhombus is a shape with 6 sides each with diagonals, the longer of the two major diagonals is phi, the other is one. These shapes have a limited number of constellations, amalgams of 3D Golden Rhombuses with a 3D Golden Rhombus of interest at the center with each side attached inverted, in the same orientation or unbound to other 3D Golden Rhombuses. Each constellation adds a 3D Golden Rhombus in either the same orientation or inverted on an unbound side of the center of each constellation, this process forms a Rule of Interaction of the 3D Golden Rhombus. Activation of a Rule of Interaction on an interesting 3D Golden Rhombus considers the environment of 3D Golden Rhombuses and adds a 3D Golden Rhombus inverted or in the same orientation as the 3D Golden Rhombus of interest.

I claim:

1. All Rules of Interaction of the 3D Golden Rhombus consisting of an additional 3D Golden Rhombus located and orientated within an unbound side of the 3D Golden Rhombus of interest's constellation.
